(19) United States
(12) Patent Application Publication
(10) Pub. No.: US 2025/0336188 A1
(43) Pub. Date: Oct. 30, 2025

(54) Object Detection Method and System Based on User-Defined Category

(71) Applicant: Hangzhou Meari Technology Co.,Ltd., Hangzhou (CN)

(72) Inventors: Gangqiang ZHAO, Hangzhou (CN); Wei JIN, Hangzhou (CN); Hongli YING, Hangzhou (CN)

(73) Assignee: Hangzhou Meari Technology Co.,Ltd., Hangzhou (CN)

(21) Appl. No.: 19/183,970

(22) Filed: Apr. 21, 2025

(30) Foreign Application Priority Data
Feb. 21, 2024 (CN) 202410190083 .9

(51) Int. Cl. G06V 10/774; G06F 40/289; G06F 40/40; G06V 10/44; G06V 10/74; G06V 10/776; G06V 10/82

(52) U.S. Cl. CPC G06V 10/7747; G06F 40/289; G06F 40/40; G06V 10/44; G06V 10/761; G06V 10/776; G06V 10/82

(57) ABSTRACT

The provided is a method and system for object detection based on user-defined categories. The method includes: a user inputting a natural language description and a related image, obtaining a detection target auxiliary input using an auxiliary characterization generation technique for a detection target based on a phrase boundary point modeling technique; calling a detection target characterization generation model based on a multimodal reconstruction and alignment network to obtain a plurality of text characterizations of the detection target; generating target reverse characterizations based on an image-adaptive target characterization matching estimation technique to meet custom requirements of the detection target; and optimizing a vision-language multimodal model based on feedback data of the detection target of the user under detection, and optimizing the vision-language multimodal model based on the feedback data during usage of custom object detection.

### TECHNICAL FIELD

The present disclosure belongs to the technical field of graphic and textual data processing, and in particular to a method and system for object detection based on user-defined categories.

### BACKGROUND TECHNOLOGY

With the advancement of artificial intelligence (AI) technologies, an increasing number of image recognition systems have been deployed, such as facial recognition and object detection. Limited by classical neural network techniques, mainstream object detection algorithms can only recognize predefined object categories (e.g., human figures, vehicles, pets, etc.) but fail to recognize undefined object types.

With the development of transformer-based neural networks, vision-language multimodal models have gained the capability to process both textual and image data simultaneously while supporting detection of undefined object categories. However, due to cost constraints, the parameter scale of such multimodal models cannot be excessively large, consequently limiting their ability to comprehend complex user text inputs-they can only interpret simple target descriptive keywords. A critical technical challenge in applying vision-language multimodal models lies in effectively converting users' natural language inputs and image inputs into appropriate text characterization for target detection.

The disclosed method for visual reasoning QA based on prior knowledge-augmented large language models (Patent Application No.: CN202310744506.2) enhances image knowledge reasoning by feeding more visual information from a small visual QA model into a large language model (LLM). While this approach leverages the LLM's reasoning capability by providing enriched inputs, the purpose of object detection based on user-defined categories is to activate the object detection capability of the vision-language multimodal model by providing appropriate inputs, which requires substantial computational resources, resulting in slow detection speed and strict input data requirements, making it unsuitable for object detection based on user-defined categories. Another disclosed method involves a method and device for image information extraction based on a pre-trained language model (Patent Application No.: CN202311132052.X), which employs prompt templates to invoke the pre-trained language model for reasoning and error correction on text information recognized from images. While this approach effectively combines language models and OCR models in a single-image text extraction scenario, its limited prompt template database cannot accommodate applications requiring large-scale user-defined object detection. A third disclosed method (Patent Application No.: CN202211013807.X) applies prompt learning to reconstruct input texts for automated QA tasks. Specifically, it classifies input texts (e.g., “Why does A malfunction?”) and appends specific prompts (e.g., “Why does A malfunction? The answer is . . . ”) to guide the language model toward more accurate responses. However, this method only processes unimodal text information and does not support multimodal (image+text) inputs, objectively increasing the length of the inputs.

### CONTENT OF THE INVENTION

The present disclosure provides a method and system for object detection based on user-defined categories, aiming to solve the problem of how to generate appropriate text characterizations of custom detection targets from user images and text inputs so as to activate the object detection capability of a vision-language multimodal model.

In order to achieve the above objective, the present disclosure adopts the following technical solutions:

A method for object detection based on user-defined categories, comprising:
obtaining input data of a user under detection, and processing the input data using an auxiliary characterization generation technique for a detection target based on a phrase boundary point modeling technique to obtain auxiliary input data of the detection target, wherein the input data includes text data and image data, and the detection target is an object detection result of the input data of the user under detection;
processing the input data and the auxiliary input data using a characterization generation technique for a detection target based on a multimodal reconstruction and alignment network to obtain text characterizations of the detection target, a count of the text characterizations being greater than or equal to two;
screening the text characterizations based on an image-adaptive target characterization matching estimation technique, and selecting text characterizations which do not meet user needs to obtain reverse characterizations;
summarizing the reverse characterizations and the text characterizations after screening to be input into a vision-language multimodal model for operation to obtain the detection target of the user under detection; and
storing feedback data of the detection target of the user under detection, and optimizing the vision-language multimodal model based on the feedback data.

Preferably, the processing the input data using an auxiliary characterization generation technique for a detection target based on a phrase boundary point modeling technique to obtain auxiliary input data of the detection target includes:
extracting, based on the text data, similar text sets from a historical text database DST, extracting, based on the image data, similar image sets from a historical image database DSI, substituting the similar image sets into the vision-language multimodal model for calculation to obtain characterization text sets corresponding to the similar image sets, and summarizing the similar text sets and the characterization text sets to obtain an auxiliary input set;
extracting key phrases of text sentences from the auxiliary input set using the auxiliary characterization generation technique for the detection target based on the phrase boundary point modeling technique, and summarizing the key phrases to obtain the auxiliary input data.

Preferably, the extracting, based on the text data, similar text sets from a historical text database DST includes: substituting texts in the historical text database DST into a formula |Emb(Dᵢ)−Emb(D_{I})| in sequence for calculation, in response to a calculation result being less than a first preset threshold, adding the corresponding texts to the similar text sets, wherein D_{I} denotes the text data, Emb(D_{I}) denotes an embedding vector of D_{I}, Dᵢ denotes an i-th text in the historical text database DST, Emb(Dᵢ) denotes an embedding vector of Dᵢ, and i denotes a non-zero natural number;
the extracting, based on the image data, similar image sets from a historical image database DSI includes: extracting a feature Feat(I_{I}) of image data I_{I} using the vision-language multimodal model, and extracting a feature Feat(Iᵢ) of an i-th image from the historical image database DSI, substituting Feat(I_{I}) and Feat(Iᵢ) into |Feat(I_{I})−Feat(Iᵢ)| for calculation, in response to a calculation result being less than a second preset threshold, adding the corresponding images to the similar image sets.

Preferably, the obtaining the key phrases includes:
selecting K_{pred} samples according to a Gaussian distribution, wherein K_{pred} is a non-zero natural number;
calculating \hat{x}₀, P^{l} and P^{r} using a trained f_{θ}(X_{μi}, Q, μᵢ) model, wherein the f_{θ}(X_{μi}, Q, μᵢ) model is a noisy neural network model, \hat{x}₀ denotes a predicted value of a phrase boundary point of a moment μᵢ, μ denotes a time series of a length φ, μ_{φ}=T, X_{μi}−1 is iterated from i=φ to i=1,

$${x}_{{μ}_{i - 1}} = \sqrt{1 - {β}_{{μ}_{i - 1}}} {\hat{x}}_{0} + \sqrt{{β}_{{μ}_{i - 1}}} \frac{{x}_{{μ}_{i}} - \sqrt{1 - {β}_{{μ}_{i}}} {\hat{x}}_{0}}{\sqrt{{β}_{{μ}_{i}}}} ,$$

X_{μi} and X_{μi-1} denote two neighboring samples of the K_{pred} samples, β_{μi-1} and β_{μi} denote variance coefficients of a predefined Gaussian distribution, Q denotes sentences in the text data, P^{l} and P^{r} denote probabilities of boundary points on the left and right sides of a phrase, respectively,

$${( {l}_{i} , {r}_{i} )}_{i = 0}^{{K}_{Pred}}$$

denote trainable parameter matrixes, G(·) denotes a trainable two-layer perception network, C_{Q} denotes an output code after Q is input into the f_{θ}(X_{μi}, Q, μᵢ) model, and C_{X} denotes enhanced noise sampling;
analyzing boundary points

$${C}_{QX}^{l} = {C}_{Q} {Z}_{Q}^{l} + {C}_{X} {Z}_{X}^{l} , {P}^{l} = G ( {C}_{QX}^{l} ) , {C}_{QX}^{r} = {C}_{Q} {Z}_{Q}^{r} + {C}_{X} {Z}_{X}^{r} , {P}^{r} = G ( {C}_{QX}^{r} ) , {Z}_{Q}^{l} , {Z}_{X}^{l} , {Z}_{Q}^{r} , {Z}_{X}^{r}$$

of K_{pred} candidate phrases according to probability values of the boundary points, wherein

$${l}_{i} = arg max {P}_{i}^{l} , {r}_{i} = arg max {P}_{i}^{r} ,$$

and l and r denote left and right boundary points of the phrase, respectively;
selecting candidate phrases having the same left and right boundary points and highest probability values, summarizing and filtering the candidate phrases, and discarding candidate phrases whose probability values are less than a third preset threshold to obtain the key phrases.

Preferably, the processing the input data and the auxiliary input data using a characterization generation technique for a detection target based on a multimodal reconstruction and alignment network to obtain text characterizations of the detection target includes:
obtaining training sample data, and jointly optimizing a loss function of a text modality, a loss function of an image modality, and a loss function of an auxiliary modality based on the training sample data to obtain a characterization encoder and a characterization generation decoder corresponding to each modality;
extracting features of the text data, the image data and the auxiliary input data, respectively, and inputting the features into the characterization encoder corresponding to each modality to obtain a primary text characterization of the detection target, a primary image characterization of the detection target, and a primary auxiliary characterization of the detection target; and
mining a target characterization feature hidden in each modal description using the primary text characterization of the detection target, the primary image characterization of the detection target, and the primary auxiliary characterization of the detection target for reconstruction and alignment to obtain a complete characterization description after merging, and inputting the complete characterization description into the corresponding characterization generation decoder to obtain the text characterizations of the detection target.

Preferably, the screening the text characterizations based on an image-adaptive target characterization matching estimation technique, and selecting text characterizations which do not meet user needs to obtain reverse characterizations includes:
enhancing the text characterizations using a contextual vector to obtain enhanced input characterization words;
extracting image features from the image data, calculating matching values between the input characterization words and the image features, and selecting text characterizations corresponding to input characterization words whose matching values are less than a fourth preset threshold to obtain the reverse characterizations, a calculation formula of the matching value being p(y|Feat)=exp(sim(Feat,f(g_{y}(Feat)))/τ)/Ω, wherein p(y|Feat) denotes the matching value,

$$Ω = {\sum }_{i = 1}^{k} exp ( sim ( Feat , f ( {g}_{i} ( Feat ) ) ) / τ ) ,$$

τ denotes a learnable hyperparameter, sim denotes a similarity between two features, Feat denotes the image feature, y denotes a text description of all the text descriptions, g_{y}(Feat) denotes the input characterization word corresponding to the text characterization y, and gᵢ(Feat) denotes enhanced input characterization words of all the text characterizations.

Preferably, before the enhancing the text characterizations using a contextual vector:
inputting the text descriptions into the vision-language multimodal model in sequence for calculation to obtain detection results, feeding back the detection results to the user under detection, the user under detection marking the detection results as correct or incorrect, if the marked detection result is incorrect, enhancing the text description corresponding to the detection result.

A system for object detection based on user-defined categories, comprising:
an auxiliary input data calculation module configured to obtain input data of a user under detection, and process the input data using an auxiliary characterization generation technique for a detection target based on a phrase boundary point modeling technique to obtain auxiliary input data of the detection target, wherein the input data includes text data and image data, and the detection target is an object detection result of the input data of the user under detection;
a text characterization calculation module configured to process the input data and the auxiliary input data using a characterization generation technique for a detection target based on a multimodal reconstruction and alignment network to obtain text characterizations of the detection target, a count of the text characterizations being greater than or equal to two;
a reverse characterization calculation module configured to screen the text characterizations based on an image-adaptive target characterization matching estimation technique, and select text characterizations which do not meet user needs to obtain reverse characterizations;
an object detection module configured to summarize the reverse characterizations and the text characterizations after screening to be input into a vision-language multimodal model for operation to obtain the detection target of the user under detection; and
a model optimization module configured to store feedback data of the detection target of the user under detection, and optimize the vision-language multimodal model based on the feedback data.

An electronic device, comprising a memory and a processor, the memory being configured to store one or more computer instructions, wherein the one or more computer instructions are executed by the processor to implement the method for object detection based on the user-defined categories described above.

A computer-readable storage medium, wherein when computer programs stored in the storage medium are executed by a computer, the method for object detection based on the user-defined categories described above is implemented.

The present disclosure has the following beneficial effects:
(1) This solution supports the technology of object detection based on user-defined categories. The user only needs to enter a language description. (i.e., the text data) and a related image (i.e., the image data) to generate a suitable text characterization of the detection target. By inputting the text characterization of the detection target into the existing vision-language multimodal model, the object detection result can be output, which can fully stimulate the object detection capacity of the vision-language multimodal model without complex model training, and has good cost-effectiveness;
(2) This solution combines the characterization generation technique for the detection target based on the multimodal reconstruction and alignment network and the image recognition capability of the vision-language multimodal model, which greatly facilitates the use of the image recognition technology for the user, and has high popularization ability;
(3) This solution does not require the amount of input data. It only requires the user to input a language description according to the intention, and the suitable text characterization of the detection target can be generated through data processing based on the auxiliary characterization generation technique for the detection target based on the phrase boundary point modeling technique, the characterization generation technique for the detection target based on the multimodal reconstruction and alignment network, and the image-adaptive target characterization matching estimation technique. After the text characterization of the detection target is input into the vision-language multimodal model for detection, the text description that best meets the user's needs can be generated, which is convenient for use, fast in detection speed and convenient for technology promotion;
(4) In order to improve the accuracy of object detection, this solution generates the auxiliary input data through the historical text database DST and the historical image database DSI. The more users use the DST and the DSI, the more text data or image data will be accumulated in the database, the more applications can be handled by a large number of users who need to perform custom category object detection. By generating the auxiliary input data, it can avoid ignoring important background information and maximize the object detection capability of the vision-language multimodal model;
(5) This solution performs synchronous multimodal training on the text data modality, the image data modality, and the auxiliary data modality, i.e., it supports simultaneous multimodal data processing. After simultaneous multimodal data processing, multimodal reconstruction and alignment processing is performed, thereby further optimizing the generation effect of the detection target text characterization.
(6) The implementation of this solution will greatly accelerate the popularization of image analysis technology, improve productivity, and improve living conditions. This solution has certain social significance.

### DESCRIPTION OF THE DRAWINGS

FIG. 1 is a flowchart of a method for object detection based on user-defined categories according to the present disclosure;

FIG. 2 is a flowchart of main steps of a system for object detection according to Embodiment 1 of the present disclosure;

FIG. 3 is a schematic diagram of an architecture of a characterization generation model for a detection target based on a reconstruction and alignment network according to Embodiment 1 of the present disclosure;

FIG. 4 is a schematic diagram of reconstruction and alignment of a multimodal target primary characterization according to Embodiment 1 of the present disclosure;

FIG. 5 is a schematic diagram of an architecture of image-adaptive target characterization matching estimation according to Embodiment 1 of the present disclosure;

FIG. 6 is a schematic structural diagram of a system for object detection according to the present disclosure.

### SPECIFIC IMPLEMENTATIONS

### Embodiment 1

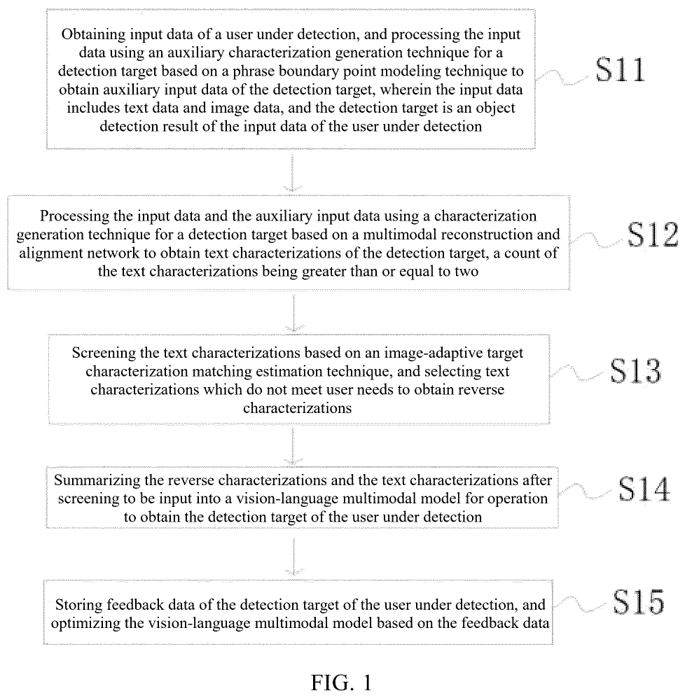

As shown in FIG. 1, a method for object detection based on user-defined categories comprises the following steps:
S11. obtaining input data of a user under detection, and processing the input data using an auxiliary characterization generation technique for a detection target based on a phrase boundary point modeling technique to obtain auxiliary input data of the detection target, wherein the input data includes text data and image data, and the detection target is an object detection result of the input data of the user under detection;
S12. processing the input data and the auxiliary input data using a characterization generation technique for a detection target based on a multimodal reconstruction and alignment network to obtain text characterizations of the detection target, a count of the text characterizations being greater than or equal to two;
S13. screening the text characterizations based on an image-adaptive target characterization matching estimation technique, and selecting text characterizations which do not meet user needs to obtain reverse characterizations;
S14. summarizing the reverse characterizations and the text characterizations after screening to be input into a vision-language multimodal model for operation to obtain the detection target of the user under detection; and
S15. storing feedback data of the detection target of the user under detection, and optimizing the vision-language multimodal model based on the feedback data.

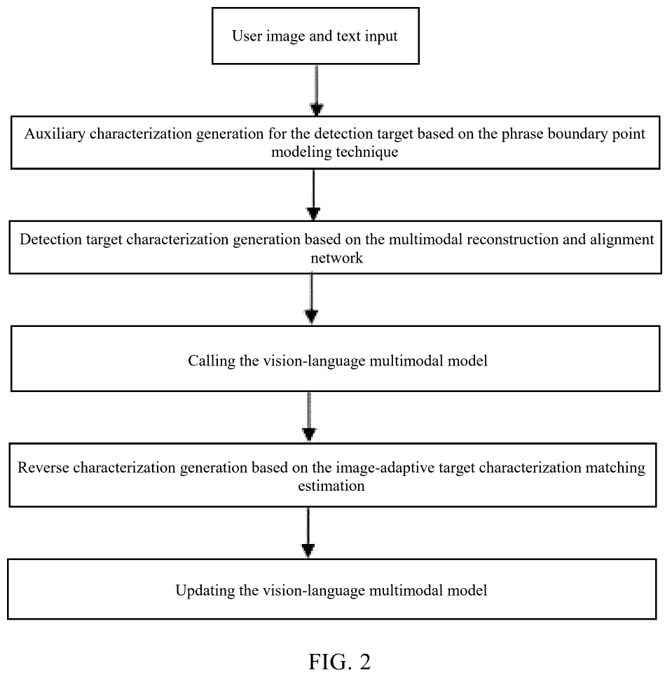

As shown in the flowchart of FIG. 2, the entire process of user-defined object detection of the present embodiment specifically includes the following steps: firstly, a user inputting a natural language description and a related image, and obtaining a detection target auxiliary input using the auxiliary characterization generation technique of the detection target based on the phrase boundary point modeling technique; secondly, calling the characterization generation model of the detection target based on the multimodal reconstruction and alignment network to obtain the plurality of text descriptions of the detection target; then, in the process of custom object detection, generating the target reverse characterizations based on the image-adaptive target characterization matching estimation technique to further meet the custom requirements of the detection target; finally, optimizing the vision-language multimodal model based on the feedback data from the process of custom object detection.

Several key contents included above are described as follows:

(1) The characterization generation technique for the detection target based on the multimodal reconstruction and alignment network: the user inputs a natural language description and a related image based on custom object detection categories. The characterization generation model for the detection target is called based on the multimodal reconstruction and alignment network to obtain the text descriptions of the detection target. The whole network is transformer-based neural network architecture.

(2) The vision-language multimodal model: a transformer-based neural network model that supports both image and text modalities. It supports inputting target description texts and images, and recognizing objects expressed in the texts and appearing in the input images. It also supports inputting images to obtain attribute description information of main objects in the images. For example, if the input target description text is “find people wearing red clothes”, the model can locate all people wearing red clothes in the input image. Text information describing the main objects in the input image can be generated by the model.

(3) The historical text database DST: a natural language text database of user-defined detection inputs. The more users, the more text data the database accumulates. For each text, its embedding vector is obtained using the vision-language multimodal model, and the text and the corresponding embedding vector are stored as one data item in the text database. The embedding vector of the text can be used as a feature description of the text, facilitating subsequent mining of similar texts.

(4) The historical image database DSI: an image data database of user-defined detection. The more users use the system, the more data the database accumulates. For each image, an image feature vector is extracted using the vision-language multimodal model, and the image and the corresponding vector are stored as a data item in the image database. The image feature vector describes semantic information of the image, facilitating subsequent mining of similar images.

(5) The auxiliary characterization generation technique for the detection target based on the phrase boundary point modeling technique: the technique that maximizes the capacity of the multimodal model to supplement important background information that may be missed by custom input to assist in the auxiliary characterization generation of the detection target with the historical information accumulated by the system.

(6) The reverse characterization generation technique based on the image-adaptive target characterization matching estimation technique: when a detection target has a plurality of description texts, characterization sentences that are not suitable for current custom requirements are selected using user mark information and the matching estimation technique during use to be used as target reverse characterizations.

(7) Optimization of the vision-language multimodal model: positive and negative feedback samples are respectively marked based on the feedback data during use of the user, the mark information including a location of an object under recognition, an object characterization text, and other information. When a certain amount of feedback data is accumulated, the vision-language multimodal model is updated, and the updated model has better detection effect.

It should be noted that in the subsequent introduction of the whole solution, training and reasoning of the multimodal detection target characterization model based on the reconstruction and alignment network, the auxiliary characterization generation technique for the detection target based on the phrase boundary point modeling technique, the reverse characterization generation technique based on the image-adaptive target characterization matching estimation, and updating the vision-language multimodal model all require to be performed on a remote server with relatively great computing power.

The above steps are as follows:

1. The auxiliary characterization generation technique for the detection target based on the phrase boundary point modeling technique.

When the user under detection inputs texts (i.e., text data) and images (i.e., image data), the user may ignore important background information, and a custom input may not be able to maximize the capability of the vision-language multimodal model. Accordingly, the historical information can be searched using the historical text database DST and the historical image database DSI accumulated by the system. The auxiliary characterizations of the detection target are generated using the phrase boundary point modeling technique.

1.1 Historical information search.

Assuming that the text currently input by the user is D_{I} and the image is I_{I}, the historical information search specifically includes the following steps:

(1) Searching for a description of the text D_{I}. In order to obtain a similar text set of the text D_{I} from the historical text database DST, let the embedding vector of the input text D_{I} be represented as Emb(D_{I}), let the embedding vector of an i-th item in the text database DST be represented as Emb(Dᵢ), the text description search is performed by searching similar vectors of Emb(D_{I}) from the text database. When a distance |Emb(Dᵢ)−Emb(D_{I})| between two text features is less than a certain threshold (the threshold is a first preset threshold), the corresponding text is added into a set S1, and the set S1 is the similar text set. Dᵢ denotes an i-th text in the historical text database DST, and i denotes a non-zero natural number.

(2) Searching for an image input I_{I} description. An approximate image support set S2 is obtained from the historical image database DSI. Specifically, a feature Feat(I_{I}) of the input image I_{I} is extracted using the vision-language multimodal model, and assume that an i-th item in the image database DSI is Feat(Iᵢ), image characterization extension is to query the image database for vectors similar to Feat(I_{I}). When a distance |Feat(I_{I})−Feat(Iᵢ)| between image features is less than a certain threshold (the threshold is a second preset threshold), the characterization text of the corresponding image (the image is an image in the similar image set) is obtained using the vision-language multimodal model, and the corresponding text is added to the set S2, and the set S2 is the characterization text set.

(3) Merging the text sets S1 and S2 into an auxiliary input set H.

The historical image and text database contains a large number of user-defined instances, thus covering a wide variety of user needs. Since descriptions contained in H come from historical user input texts and images similar to a current input, it is possible to contain unclear needs of user-defined detection. In order to further mine the key information in H, key phrases are generated using the phrase boundary point modeling technique. The user's text input D_{I}, the user's image input I_{I} and the key phrases in H are jointly used as the input of the multimodal reconstruction and alignment network.

1.2 Auxiliary characterization generation based on phrase boundary point modeling.

Let a sentence description in the set H be Q, whose length is M. The purpose of auxiliary characterization generation is to find key phrases

$$Ph = {\{ ( {I}_{i} , {r}_{i} ) \}}_{i = 0}^{N}$$

in Q, wherein N denotes a count of phrases, Iᵢ, rᵢ respectively denote left and right sides of the phrase in Q, and Ph denotes the key phrase. The entire auxiliary characterization generation can be modeled as a phrase boundary point denoising and restoration process. Specifically, the boundary point of each phrase is used as a data sampling point. A boundary point forward noise addition process gradually adds Gaussian noise to simulate a random distribution of boundary points. A boundary point reverse denoising process gradually removes the noise to restore real locations of the boundary points.

1.2.1 Boundary point forward noise adding process.

The boundary point forward noise addition process is modeled by gradually adding the Gaussian noise to the phrase boundary points. In order to align the count of phrases that is different in different description, let the maximum count of phrases be K, K>N, K and N are both non-zero natural numbers. For convenience, use BϵR^{K×2} to represent K×2 boundary points of K phrases. Let a starting point sample of phrase boundary sampling be X₀=B, by the forward noise addition process, the sample at a moment t can be obtained as:

$${x}_{t} = \sqrt{{ω}_{t}} {x}_{0} + \sqrt{1 - {ω}_{t}} σ ;$$

wherein xₜ denotes the sample at the moment t, σ denotes a noise sample that conforms to the Gaussian distribution, and ωₜ is defined as follows:

$${ω}_{t} = {\prod }_{s = 0}^{t} ( 1 - {β}_{s} ) ;$$

βₛϵ(0,1) denotes a variance coefficient of a predefined Gaussian distribution. In this way, the sample at each moment, x₀, X₁, . . . , X_{T}ϵR^{K×2} can be obtained.

1.2.2 Boundary point reverse denoising process.

The boundary point reverse denoising process is a process of perform reverse denoising on a noisy sample X_{T} (i.e., a sample X_{T} at a maximum moment) to obtain an original sample. Assuming that μ denotes a time series of a length φ, μ_{φ}=T. The process from noise sampling X_{μφ} to X_{μφ}−1 is as follows:

$${\hat{x}}_{0} = {f}_{θ} ( {x}_{{μ}_{i}} , Q , {μ}_{i} ) ;$$

$${σ}_{{μ}_{i}} = \frac{{x}_{{μ}_{i}} - \sqrt{1 - {β}_{{μ}_{i}}} {\hat{x}}_{0}}{\sqrt{{β}_{{μ}_{i}}}} ;$$

$${x}_{{μ}_{i - 1}} = \sqrt{1 - {β}_{{μ}_{i - 1}}} {x}_{0} + \sqrt{{β}_{{μ}_{i - 1}}} {σ}_{{μ}_{i}} .$$

Where \hat{x}₀ and \hat{σ}_{μ}_{ᵢ} denote a predicted value of a phrase boundary point of a moment μᵢ and a noise predicted value. x_{μ}_{ᵢ} and x_{μ}_{_{i−1}} denote neighboring samples, β_{μi}−1 and β_{μi} denote the variance coefficients of the predefined Gaussian distribution. f_{θ}(x_{μ}_{ᵢ}, Q, μᵢ) denotes a trainable denoising neural network whose input is the noise sample x_{μ}_{ᵢ} and the sentence Q and output is the phrase boundary \hat{x}₀. f_{θ} consists of two parts: a complete sentence encoder and a phrase decoder. The complete sentence encoder inputs the sentence Q (Q is the sentence in the text data) and outputs the code C_{Q}ϵR^{M×h} of the entire sentence. The phrase decoder first obtains K noise samples C_{X}ϵR^{k×h}, and then obtains C_{X} to improve the encoding effect. Two attention layers are added, wherein a first attention layer captures interaction information within C_{X}, and a second attention layer captures interaction information between C_{X} and C_{Q}. The enhanced noise can be expressed as:

$${C}_{X} = F ( {C}_{Q} , {C}_{X} ) + {ϑ}_{t} ;$$

where F denotes two attention layers and ϑₜ denotes a sinusoidal pulse signal.

For the left and right boundary points {l, r} of each phrase, first fusion expressions

$${C}_{QX}^{l} and {C}_{QX}^{r}$$

are calculated, then probability expressions of the left and right boundary points are calculated:

$${C}_{QX}^{l} = {C}_{Q} {Z}_{Q}^{l} + {C}_{X} {Z}_{X}^{l} ;$$

$${P}^{l} = G ( {C}_{QX}^{l} ) ;$$

$${C}_{QX}^{r} = {C}_{Q} {Z}_{Q}^{r} + {C}_{X} {Z}_{X}^{r} ;$$

$${P}^{r} = G ( {C}_{QX}^{r} ) .$$

Where

$${Z}_{Q}^{l} , {Z}_{X}^{l} , {Z}_{Q}^{r} , {Z}_{X}^{r}$$

denote trainable parameter matrixes, G(·) denotes a trainable two-layer perceptron network, and P^{l} and P^{r} denote probabilities of the boundary points on the left and right sides of the phrase.

1.2.3 Denoising neural network training process.

Assuming that the count of marked phrase training samples is Num, the count of phrases predicted by the boundary point model is K, and for training, the marked samples need to match with prediction results. The matching results are denoted as \hat{ρ}, and \hat{ρ}(i) denotes a marked sample corresponding to an i-th prediction result. In this way, the boundary point reverse denoising process is trained a maximum predictive likelihood function:

$${L}_{P} = - {\sum }_{i = 1}^{K} log {P}_{i}^{l} ( {\hat{ρ}}^{l} ( i ) ) + log {P}_{i}^{r} ( {\hat{ρ}}^{r} ( i ) ) ;$$

where \hat{ρ}^{l}(i), \hat{ρ}^{r}(i) denote an optimal matching index of the left and right boundary points, respectively.

1.2.4 Phrase boundary point generation process.

After completing the training of the boundary point denoising neural network, accurate locations of the boundary points can be generated through the following steps.
(1) First, K_{Pred} samples are sampled from the Gaussian distribution; x_{T}ϵR^{K}^{_{Pred}}^{×2};
(2) Next, a trained f_{θ}(x_{μ}_{ᵢ}, Q, μᵢ) model is called to calculate \hat{x}₀, P^{l} and P^{r}. μ denotes a time series of a length φ, X_{μi-1} is iterated from i=φ to i=l as follows:

$${x}_{{μ}_{i - 1}} = \sqrt{1 - {β}_{{μ}_{i - 1}}} {\hat{x}}_{0} + \sqrt{{β}_{{μ}_{i - 1}}} \frac{{x}_{{μ}_{i}} - \sqrt{1 - {β}_{{μ}_{i}}} {\hat{x}}_{0}}{\sqrt{{β}_{{μ}_{i}}}} ;$$

(3) Then boundary points

$${( {l}_{i} , {r}_{i} )}_{i = 0}^{{K}_{P r e d}}$$

of K_{Pred} candidate phrases are analyzed according to predicted probability values of the boundary points, wherein

$${l}_{i} = arg max {P}_{i}^{l} , {r}_{i} = arg max {P}_{i}^{r} ;$$

(4) Finally, deduplication and filtering operations are performed. The deduplication operation is to select candidate phrases having the same left and right boundary points and highest probability values. The filtering operation is to discard candidate phrases whose probability values are less than a certain threshold (i.e., the third preset threshold).

After the above operations, the key phrases are obtained, and the auxiliary input data is obtained after summarization.

2. The characterization generation technique for the detection target based on the multimodal reconstruction and alignment network.

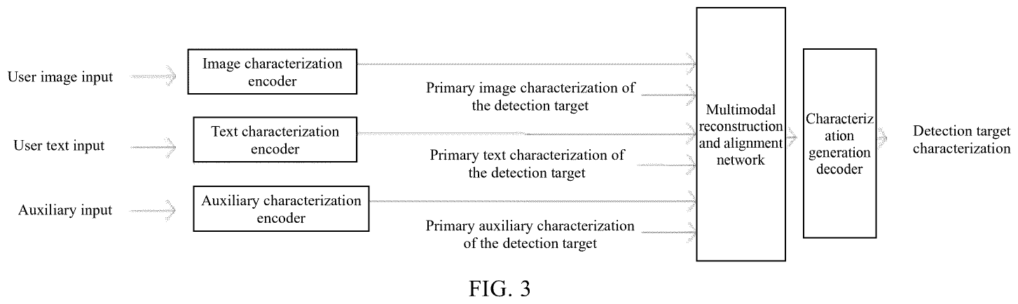

When the user customizes the object detection target, the user inputs a natural language description D and a related image I. In order to express the user's true intention, the purpose of detecting the target characterization is to generate an accurate text characterization T={ω₁, ω₂, . . . , ω_{N}}, wherein the text contains N characters. The general approach is to use image and text training data to obtain a target characterization generation model of each modality. In practical applications, due to the difficulty in obtaining the training data, when the amount of the training data is relatively small, it is difficult to train the model of each modality separately. Accordingly, the characterization generation technique for the detection target based on multimodal reconstruction and alignment network is proposed. The descriptions of different modalities describe the features of the detection target from different dimensions, and the reconstruction and alignment network is configured to align the descriptions of the plurality of modalities to extract the important common features of the multimodal descriptions and filter out the noise descriptions. The architecture of the model is shown in FIG. 3, where the auxiliary input is generated by the auxiliary characterization generation technique for the detection target based on historical image and text information search. That is, the auxiliary input data finally obtained in step 1 specifically includes the following main parts:
(1) An image characterization encoder: a neural network that extracts information from the input image, and generates a primary image characterization of the detection target using a deformable neural network architecture.
(2) A text characterization encoder: a neural network that extracts information from the input text, and generates a primary text description of the detection target using a deformable neural network architecture.
(3) An auxiliary characterization encoder: a neural network that extracts information from historical user inputs, and generates a primary auxiliary characterization of the detection target using a deformable neural network architecture.
(4) A multimodal reconstruction and alignment network: multimodal description information describes the detection target from different angles. The reconstruction and alignment network extracts important common features from multimodal descriptions and filters out noise descriptions through a feature reconstruction technology, enhancing the accuracy of subsequent detection target characterization.
(5) A characterization generation encoder: a neural network that extracts information from the reconstructed primary characterization of the multimodal target, and generates a final custom detection target characterization using a deformable neural network architecture.

After obtaining a certain amount of training data, the training process is divided into two steps. First, joint optimization of loss functions (i.e., the loss function of the text modality, the loss function of the image modality, and the loss function of the auxiliary modality) is performed to obtain the characterization encoder and the characterization generation decoder corresponding to each modality. Then the generation effect of the target characterization is further optimized by reconstructing and aligning the primary target characterizations of the plurality of modalities.

2.1 Multimodal reconstruction and alignment training.

The first step of training is to perform I simultaneous multimodal training. The steps of characterization generation of the detection target based on the simultaneous multimodal training are as follows:
(1) inputting an image I, wherein first a primary image characterization P_{I} of the detection target is generated, and then a detection target characterization T of P_{I} is generated.
(2) Inputting a natural language description D, wherein first a primary text characterization P_{D} of the detection target is generated, and then a detection target characterization T of P_{D} is generated.
(3) Inputting an auxiliary characterization A, wherein first a primary auxiliary characterization P_{A} of the detection target is generated, and then a detection target characterization T of P_{A} is generated.

In order to perform the simultaneous multimodal training, first an image feature representation R_{I}, a text feature representation R_{D}, and an auxiliary feature representation R_{A} are obtained. Secondly, the primary target characterization of each modality is generated, namely, the primary image characterization P_{I} of the detection target, the primary text description P_{D} of the detection target, and the primary auxiliary characterization P_{A} of the detection target. The dimension of each target primary characterization is N_{P}×d, where N_{P} denotes the count of target descriptions, and d denotes the dimension of each target characterization. All the features and primary target characterizations are as follows:

$${\hat{P}}_{1} = [ {P}_{1} ; {R}_{1} ] , {\hat{P}}_{D} = [ {P}_{D} ; {R}_{D} ] , {\hat{P}}_{A} = [ {P}_{A} ; {R}_{A} ]$$

wherein \hat{P}_{I}, \hat{P}_{D}, and \hat{P}_{A} denote sets of the corresponding features and primary target characterizations, respectively, [.;.] denotes the connection operation.

Then the primary target characterization of each modality is used as the input of the corresponding modality decoder, and the decoder is configured to generate the detection target characterization of the corresponding modality. Assuming that the correct marking of the data is: T={ω₁, ω₂, . . . , ω_{N}}, the training process is optimized by minimizing a natural language generation loss function:

$$\begin{matrix}{L}^{I} = - {\sum }_{t = 1}^{N} log ( p ( {w}_{t} \vert {w}_{1 : t - 1} ; {\hat{P}}_{I} , I ) ) ; \\ {L}^{D} = - {\sum }_{t = 1}^{N} log ( p ( {w}_{t} \vert {w}_{1 : t - 1} ; {\hat{P}}_{D} , D ) ) ; \\ {L}^{A} = - {\sum }_{t = 1}^{N} log ( p ( {w}_{t} \vert {w}_{1 : t - 1} ; {\hat{P}}_{A} , A ) ) ;\end{matrix}$$

where L^{I}, L^{D}, and L^{A} denotes the loss functions corresponding to the three modalities, respectively.

Finally, the weighted addition of the three loss functions is the optimization goal of the simultaneous multimodal training:

$${L}_{S} = {α}_{1} {L}^{I} + {α}_{2} {L}^{D} + {α}_{3} {L}^{A} ;$$

where α_{1,2,3} denote weight coefficients for controlling the three modal losses, L_{S} denotes a total loss function, and this embodiment solution selects α₁=1, α₂=1, α₃=0.5.

Through the above process, the characterization encoder and the characterization generation decoder corresponding to each modality are obtained after training.

The second step of training is to perform multimodal reconstruction and alignment training. After completing the detection target characterization model training for each modality, in order to enhance the effect, the reconstruction and alignment training is performed on the primary target characterizations of the plurality of modalities. The process of reconstruction and alignment can extract a plurality of important common features of modal descriptions while filtering out noise descriptions.

Specifically, all the three modalities are reconstructed. Assuming that the primary target characterizations of the three modalities are P_{I}, P_{D}, and P_{A}, taking the primary image target characterization P_{I} as an example, the target characterization features hidden in each modal description are mined using the image characterization P_{I}, specifically as follows:

$$\begin{matrix}{P}_{I \to I} = α {P}_{I} = {\sum }_{k = 1}^{{N}_{p}} {α}_{k} {p}_{k} , α = softmax ( {P}_{I} {P}_{I}^{T} ) ; \\ {P}_{I \to D} = β {P}_{D} = {\sum }_{k = 1}^{{N}_{p}} {β}_{k} {p}_{k} , β = softmax ( {P}_{1} {P}_{D}^{T} ) ; \\ {P}_{I \to A} = γ {P}_{A} = {\sum }_{k = 1}^{{N}_{p}} {γ}_{k} {p}_{k} , γ = softmax ( {P}_{I} {P}_{A}^{T} ) ;\end{matrix}$$

where α, β, and γ denote weight coefficients, respectively.

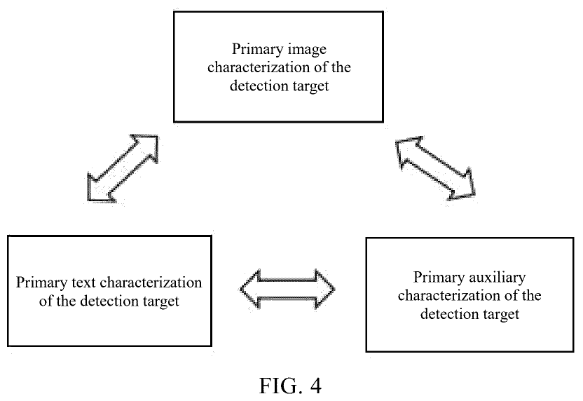

Similarly, the process of reconstruction and alignment is performed on the primary text characterization and the primary auxiliary characterization in the same way to obtain the corresponding reconstructed expressions, such as P_{D→I}, P_{D→D}, P_{D→A} and P_{A→I}, P_{A→D}, P_{A→A}. A complete alignment description is obtained by merging a plurality of expressions after reconstruction and alignment \hat{P}={P_{I→I}, P_{I→D}, P_{I→A}, P_{D→I}, P_{D→D}, P_{D→A}, P_{A→I}, P_{A→D}, P_{A→A}}. The process of reconstruction and alignment is a process of mutual alignment of the plurality of modalities, as shown in FIG. 4.

For training, let the correct marking of the data be: T={ω₁, ω₂, . . . , ω_{N}}. The entire network is trained by minimizing the natural language generation loss function:

$${L}_{M} = - {\sum }_{t = 1}^{N} log ( p ( {w}_{t} \vert {w}_{1 : t - 1} ; \hat{P} , I , D , A ) ) ;$$

where L_{M} is the loss function corresponding to the reconstructed modality.

After the training is completed, the entire generation process follows from input to the reconstruction and alignment expression to the detection target characterization in the reasoning stage as follows:

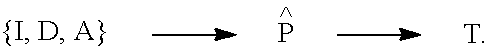

After the multimodal reconstruction and alignment training, the important common features of the three modalities are extracted and then decoded by the corresponding characterization generation decoders to obtain the text characterization of the detection target.

2.2 Detection target multiple characterization generation.

By performing data augmentation on the input image, such as adding noise, rotating, etc., and performing operations such as synonym replacement on the input text description, the model input can be slightly changed to generate a plurality of detection target characterizations and form a set Σ. Accordingly, the count of the text characterizations is greater than or equal to two, which is multiple. In the subsequent stage of custom object detection application, appropriate detection target characterizations and detection target reverse characterizations are generated.

3. The reverse characterization generation technique based on the image-adaptive target characterization matching estimation.

The reverse characterization generation is to select characterization sentences which are not suitable for the current custom requirements (i.e., select inappropriate text characterizations). This solution generates the reverse characterizations of the detection target based on the image-adaptive target characterization matching estimation technique.

3.1 The image-adaptive target characterization matching estimation.

The core of the target characterization matching estimation is to adaptively estimate a matching degree of a characterization word with an image for each input image. In order to fully utilize the differentiable learning characteristics of neural networks, the characterization word is enhanced using a learnable contextual vector and a similarity between a characterization word text and an image feature is estimated based on the content of the input image. The contextual vector can extract custom information of the current input image.

Specifically, for a characterization sentence, such as “an image of an object a”, K learnable contextual vectors {u₁, u₂, . . . , u_{K}} and a lightweight meta-network m_{θ} are introduced, where θ denotes parameters of the meta-network. Each contextual vector is obtained by the following formula:

$${u}_{k} ( Feat ) = {u}_{k} + {m}_{θ} ( Feat ) ;$$

where kϵ{1, 2, . . . , K} Feat denotes features of the corresponding image.

The input characterization word t; enhanced based on the contextual vector is used, that is:

$${g}_{i} ( Feat ) = \{ {u}_{1} ( Feat ) , {u}_{2} ( F e a t ) , … , {u}_{K} ( Feat ) , {t}_{i} \} ;$$

in this case, the matching probability between the characterization word t_{y} and the image is calculated as follows:

$$p ( y \vert Feat ) = exp ( sin ( Feat , f ( {g}_{y} ( F e a t ) ) ) / τ ) / Ω ;$$

where

$$Ω = {\sum }_{i = 1}^{k} exp ( sin ( Feat , f ( {g}_{i} ( F e a t ) ) ) / τ ) ,$$

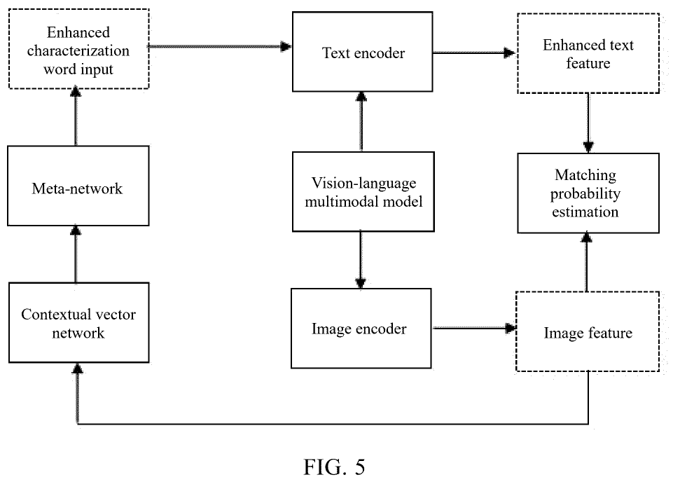

τ denotes a learnable hyperparameter, sim denotes the similarity between two features, y denotes a text description of all the text descriptions, g_{y}(Feat) denotes the input characterization word corresponding to the text characterization y, and gᵢ(feat) denotes enhanced input characterization words of all the text characterizations, that is, the total input characterization words. The entire calculation process is shown in FIG. 5.

During the training process, the contextual variables {u₁, u₂, . . . , u_{K}} and the meta-network parameters θ are updated simultaneously. The meta-network is a two-layer neural network whose input is the image feature code generated by the image feature encoder. The length of each contextual variable {u₁, u₂, . . . , u_{K}} is consistent with the length of the text feature output by the vision-language model. Each piece of input data contains the images and the corresponding description texts. The training goal is to maximize the similarity between the image features and the corresponding characterization text features.

3.2 Target reverse characterization generation based on the matching estimation technique.

When the user finds and marks a false report during the process of using the custom detection target characterization, the system calls the approach of image-adaptive target characterization matching estimation to generate the target reverse characterizations. The specific steps are as follows:
(1) a target characterization score table Π is established, Πᵢ denotes a score corresponding to an i-th characterization in the target characterization set Σ. Initial scores of all the characterizations are set to 0. A characterization score table is maintained for each user.
(2) The system pushes an image recognition result to the user. That is, the text characterization is input into the vision-language multimodal model to obtain a recognition result to be fed back to the user under detection, and the user performs marking. By default, the recognition result is marked as correct. When user marks that the recognition result is incorrect, it is assumed that the input text characterization does not reflect the user's true intention.
(3) When the user mark false report occurs, the text description and the image of the false report detection target are input into the image-adaptive target characterization matching estimation algorithm to calculate a matching value p(y|Feat) between the image feature Feat and the text characterization y. When the matching value of the target description (i.e., the text description of the detection target) is less than a certain threshold (i.e., a fourth preset threshold value), the target characterization is selected as the reverse characterization of the detection target.

The usage of the reverse characterization is as follows. For example, a reverse characterization is “people wearing red raincoats”, and the user's current text characterization is “detecting people wearing red clothes”, the text characterization of the detection target finally input to the vision-language multimodal model is “detecting people wearing red clothes, but not detecting people wearing red raincoats”.

3.3 Target reverse characterization generation based on language model logical reasoning.

In addition to the image-adaptive target characterization matching estimation technique, it is also possible to analyze the causes of the false report and mine possible reverse characterizations of the detection target using the large language model's logical reasoning ability and object attribute descriptions. The large language model not only uses a large amount of text data and manual feedback information for training, but also has a parameter scale of hundreds of billions, so it has a certain intelligence emergence capability and can complete tasks such as answering text questions and text logical reasoning. The vision-language multimodal model can generate the description information of the main objects in the input image. When the user feedback false report occurs, the object attribute description information and the detection target characterizations are input into the large language model, so as to find the semantic differences and analyze the causes of the false report.

Regarding a user feedback on the false report as an example, assuming that the current user-defined target characterization is to “find people wearing red clothes”, while the output of the vision-language multimodal model for the current image is “people wearing red raincoats”, “black cats”, etc., in order to call the logical reasoning ability of the large language model, the input to the large language model is: the image contains “people wearing red raincoats”, “black cats”, etc., “people wearing red clothes” are detected in the image, the user reports that the detection is wrong, please explain the reason. The semantic differences between “red clothes” and “red raincoats” can be obtained by large model reasoning. After obtaining the reason of the false report, “people wearing red raincoats” can be used as the target reverse characterizations to improve the custom object detection effect.

4. Optimization of the vision-language multimodal model.

The vision-language multimodal model is trained by using a certain number of images and mark information. Since the training data cannot cover all application scenarios, and the parameter scale of the vision-language multimodal model is relatively small, a model cannot cover all application scenarios. In order to improve the adaptability of the vision-language multimodal model to actual application scenarios, the model is optimized based on the user feedback data during use.

Specifically, the feedback positive samples and negative samples are marked separately based on the feedback results of the user during use (i.e. the feedback data of the user under detection after obtaining the detection target), and the mark information contains a location of an object to be recognized, an object characterization text, etc. When a certain amount of feedback data is accumulated, the vision-langue multimodal model is optimized. The optimization process is to adjust some parameters of the neural network model based on the existing model. The goal of the optimization is to enable as many feedback samples as possible to recognize the correct answer. Compared with model retraining, model optimization can complete training in a short time, saving a lot of time. The optimized model generally has better detection effect.

### Embodiment 2

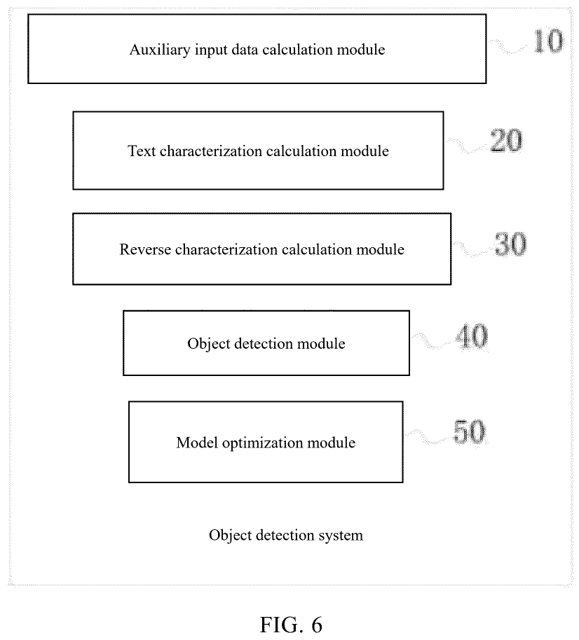

As shown in FIG. 6, a system for object detection based on user-defined categories comprises:
an auxiliary input data calculation module 10 configured to obtain input data of a user under detection, and process the input data using an auxiliary characterization generation technique for a detection target based on a phrase boundary point modeling technique to obtain auxiliary input data of the detection target, wherein the input data includes text data and image data, and the detection target is an object detection result of the input data of the user under detection;
a text characterization calculation module 20 configured to process the input data and the auxiliary input data using a characterization generation technique for a detection target based on a multimodal reconstruction and alignment network to obtain text characterizations of the detection target, a count of the text characterizations being greater than or equal to two;
a reverse characterization calculation module 30 configured to screen the text characterizations based on an image-adaptive target characterization matching estimation technique, and select text characterizations which do not meet user needs to obtain reverse characterizations;
an object detection module 40 configured to summarize the reverse characterizations and the text characterizations after screening to be input into a vision-language multimodal model for operation to obtain the detection target of the user under detection; and
a model optimization module 50 configured to store feedback data of the detection target of the user under detection, and optimize the vision-language multimodal model based on the feedback data.

In one embodiment of the above system, in the auxiliary input data calculation module 10, the input data of the user under detection is obtained, and the input data is processed by the auxiliary characterization generation technique for the detection target based on the phrase boundary point modeling technique to obtain the auxiliary input data of the detection target, wherein the input data includes the text data and the image data, and the detection target is the object detection result of the input data of the user under detection. In the text characterization calculation module 20, the input data and the auxiliary input data are processed using the characterization generation technique for the detection target based on the multimodal reconstruction and alignment network to obtain the text characterizations of the detection target, the count of text depictions being greater than or equal to two. In the reverse characterization calculation module 30, the text characterizations are screened using the image-adaptive target characterization matching estimation technique to select text characterizations which do not meet the user's custom needs to obtain the reverse characterizations. In the object detection module 40, the reverse characterizations and the text characterizations after screening are summarized and input into the vision-language multimodal model for calculation to obtain the detection target of the user under detection. In the model optimization module 50, the feedback data of the detection target of the user under detection is stored, and the vision-language multimodal model is optimized based on the feedback data.

### Embodiment 3

The embodiment provides an electronic device based on the above embodiments.

### Embodiment 4

The embodiment provides a storage medium based on the above embodiments.

The above is only a specific embodiment of the present disclosure, but the technical features of the present disclosure are not limited thereto. Any changes or modifications made by those skilled in the art within the scope of the present disclosure are included in the patent scope of the present disclosure.

What is claimed is:

1. A method for object detection based on user-defined categories, comprising:
obtaining input data of a user under detection, extracting, based on text data, similar text sets from a historical text database DST, extracting, based on image data, similar image sets from a historical image database DSI, substituting the similar image sets into a vision-language multimodal model for calculation to obtain characterization text sets corresponding to the similar image sets, and summarizing the similar text sets and the characterization text sets to obtain an auxiliary input set; extracting key phrases of text sentences from the auxiliary input set using an auxiliary characterization generation technique for a detection target based on a phrase boundary point modeling technique, and summarizing the key phrases to obtain auxiliary input data, wherein the input data comprises the text data and the image data, and the detection target is an object detection result of the input data of the user under detection; the extracting, based on the text data, the similar text sets from the historical text database DST comprises: substituting texts in the historical text database DST into a formula |Emb(Dᵢ)−Emb(D_{I})| in sequence for calculation, in response to a calculation result being less than a first preset threshold, adding corresponding texts to the similar text sets, wherein D_{I} denotes the text data, Emb(D_{I}) denotes an embedding vector of D_{I}, Dᵢ denotes an i-th text in the historical text database DST, Emb(Dᵢ) denotes an embedding vector of Dᵢ, and i denotes a non-zero natural number; the extracting, based on the image data, the similar image sets from the historical image database DSI comprises: extracting a feature Feat(I_{I}) of image data I_{I} using the vision-language multimodal model, and extracting a feature Feat(I_{I}) of an i-th image from the historical image database DSI, substituting Feat(I_{I}) and Feat(Iᵢ) into |Feat(I_{I})−Feat(Iᵢ)| for calculation, in response to a calculation result being less than a second preset threshold, adding corresponding images to the similar image sets;
obtaining training sample data, and jointly optimizing a loss function of a text modality, a loss function of an image modality, and a loss function of an auxiliary modality based on the training sample data to obtain a characterization encoder and a characterization generation decoder corresponding to each modality; extracting features of the text data, the image data and the auxiliary input data, respectively, and inputting the features into the characterization encoder corresponding to each modality to obtain a primary text characterization of the detection target, a primary image characterization of the detection target, and a primary auxiliary characterization of the detection target; mining a target characterization feature hidden in each modal description using the primary text characterization of the detection target, the primary image characterization of the detection target, and the primary auxiliary characterization of the detection target for reconstruction and alignment to obtain a complete characterization description after merging, and inputting the complete characterization description into a corresponding characterization generation decoder to obtain text characterizations of the detection target, a count of the text characterizations being greater than or equal to two;
enhancing the text characterizations using a contextual vector to obtain enhanced input characterization words; extracting image features from the image data, calculating matching values between the input characterization words and the image features, and selecting text characterizations corresponding to input characterization words whose matching values are less than a fourth preset threshold to obtain reverse characterizations, a calculation formula of the matching value being p(y|Feat)=exp(sin(Feat,f(g_{y}(Feat)))/τ)/Ω, wherein p(y|Feat) denotes the matching value,
$$Ω = {\sum }_{i = 1}^{k} exp ( sin ( Feat , f ( {g}_{i} ( F e a t ) ) ) / τ ) ,$$
τ denotes a learnable hyperparameter, sim denotes a similarity between two features, Feat denotes the image feature, y denotes a text description of text descriptions, p(y|Feat) denotes the input characterization word corresponding to a text characterization y, and gᵢ(Feat) denotes enhanced input characterization words of the text characterizations;
summarizing the reverse characterizations and the text characterizations after screening to be input into a vision-language multimodal model for operation to obtain the detection target of the user under detection; and
storing feedback data of the detection target of the user under detection, and optimizing the vision-language multimodal model based on the feedback data.

2. The method according to claim 1, wherein the obtaining the key phrases comprises:
selecting K_{Pred} samples according to a Gaussian distribution, wherein K_{Pred} is a non-zero natural number;
calculating \hat{x}₀, P^{l} and P^{r} using a trained f_{θ}(x_{μ}_{ᵢ}, Q, μᵢ) model, wherein the f_{θ}(x_{μ}_{ᵢ}, Q, μᵢ) model is a noisy neural network model, \hat{x}₀ denotes a predicted value of a phrase boundary point of a moment μᵢ, μ denotes a time series of a length φ, μ_{φ}=T, X_{μi-1} is iterated from i=φ to
$$i = 1 , {x}_{{μ}_{i - 1}} = \sqrt{1 - {β}_{{μ}_{i - 1}}} {\hat{x}}_{0} + \sqrt{{β}_{{μ}_{i - 1}}} \frac{{x}_{{μ}_{i}} - \sqrt{1 - {β}_{{μ}_{i}}} {\hat{x}}_{0}}{\sqrt{{β}_{{μ}_{i}}}} ,$$
X_{μi} and X_{μi-1} denote two neighboring samples of the K_{Pred} samples, β_{μi-1} and β_{μi} denote variance coefficients of a predefined Gaussian distribution, Q denotes sentences in the text data, P^{l} and P^{r} denote probabilities of boundary points on left and right sides of a phrase, respectively,
$${C}_{QX}^{l} = {C}_{Q} {Z}_{Q}^{l} + {CxZ}_{X}^{l} , {P}^{l} = G ( {C}_{QX}^{l} ) , {C}_{QX}^{r} = {C}_{Q} {Z}_{Q}^{r} + {CxZ}_{X}^{r} , {P}^{r} = G ( {C}_{QX}^{r} ) ,$$
$${Z}_{Q}^{l} , {Z}_{X}^{l} , {Z}_{Q}^{r} , {Z}_{X}^{r}$$
denote trainable parameter matrixes, G(·) denotes a trainable two-layer perception network, C_{Q} denotes an output code after Q is input into the f_{θ}(x_{μi}, Q, μᵢ) model, and C̅_{X} denotes enhanced noise sampling;
analyzing boundary points
$${( {l}_{i} , {r}_{i} )}_{i = 0}^{{K}_{Pred}}$$
of K_{Pred} candidate phrases according to probability values of the boundary points, wherein
$${l}_{i} = arg max {P}_{i}^{l} , {r}_{i} = arg max {P}_{i}^{r} ,$$
and l and r denote left and right boundary points of the phrase, respectively;
selecting candidate phrases having the same left and right boundary points and highest probability values, summarizing and filtering the candidate phrases, and discarding candidate phrases whose probability values are less than a third preset threshold to obtain the key phrases.

3. The method according to claim 1, wherein
before the enhancing the text characterizations using the contextual vector:
inputting the text descriptions into the vision-language multimodal model in sequence for calculation to obtain detection results, feeding back the detection results to the user under detection, the user under detection marking the detection results as correct or incorrect, when a marked detection result is incorrect, enhancing the text description corresponding to the detection result.

4. A system for object detection based on user-defined categories, comprising:
an auxiliary input data calculation module configured to obtain input data of a user under detection, comprising extracting, based on text data, similar text sets from a historical text database DST, extracting, based on image data, similar image sets from a historical image database DSI, substituting the similar image sets into a vision-language multimodal model for calculation to obtain characterization text sets corresponding to the similar image sets, and summarizing the similar text sets and the characterization text sets to obtain an auxiliary input set; extracting key phrases of text sentences from the auxiliary input set using an auxiliary characterization generation technique for a detection target based on a phrase boundary point modeling technique, and summarizing the key phrases to obtain auxiliary input data, wherein the input data comprises the text data and the image data, and the detection target is an object detection result of the input data of the user under detection; the extracting, based on the text data, the similar text sets from the historical text database DST comprises: substituting texts in the historical text database DST into a formula |Emb(Dᵢ)−Emb(D_{I})| in sequence for calculation, in response to a calculation result being less than a first preset threshold, adding corresponding texts to the similar text sets, wherein D_{I} denotes the text data, Emb(D_{I}) denotes an embedding vector of D_{I}, Dᵢ denotes an i-th text in the historical text database DST, Emb(Dᵢ) denotes an embedding vector of Dᵢ, and i denotes a non-zero natural number; the extracting, based on the image data, the similar image sets from the historical image database DSI comprises: extracting a feature Feat(I_{I}) of image data I_{I} using the vision-language multimodal model, and extracting a feature Feat(Iᵢ) of an i-th image from the historical image database DSI, substituting Feat(I_{I}) and Feat(Iᵢ) into |Feat(I_{I})−Feat(Iᵢ)| for calculation, in response to a calculation result being less than a second preset threshold, adding corresponding images to the similar image sets;
a text characterization calculation module configured to obtain training sample data, comprising jointly optimizing a loss function of a text modality, a loss function of an image modality, and a loss function of an auxiliary modality based on the training sample data to obtain a characterization encoder and a characterization generation decoder corresponding to each modality; extracting features of the text data, the image data and the auxiliary input data, respectively, and inputting the features into the characterization encoder corresponding to each modality to obtain a primary text characterization of the detection target, a primary image characterization of the detection target, and a primary auxiliary characterization of the detection target; mining a target characterization feature hidden in each modal description using the primary text characterization of the detection target, the primary image characterization of the detection target, and the primary auxiliary characterization of the detection target for reconstruction and alignment to obtain a complete characterization description after merging, and inputting the complete characterization description into a corresponding characterization generation decoder to obtain text characterizations of the detection target, a count of the text characterizations being greater than or equal to two;
a reverse characterization calculation module configured to enhance the text characterizations using a contextual vector to obtain enhanced input characterization words; extract image features from the image data, calculate matching values between the input characterization words and the image features, and select text characterizations corresponding to input characterization words whose matching values are less than a fourth preset threshold to obtain reverse characterizations, a calculation formula of the matching value being p(y|Feat)=exp(sin(Feat,f(g_{y}(Feat)))/τ)/Ω, wherein p(y|Feat) denotes the matching value,
$$Ω = {\sum }_{i = I}^{k} exp ( sin ( Feat , f ( {g}_{i} ( Feat ) ) ) / τ ) ,$$
τ denotes a learnable hyperparameter, sim denotes a similarity between two features, Feat denotes the image feature, y denotes a text description of text descriptions, p(y|Feat) denotes the input characterization word corresponding to a text characterization y, and gᵢ(Feat) denotes enhanced input characterization words of the text characterizations;
an object detection module configured to summarize the reverse characterizations and the text characterizations after screening to be input into a vision-language multimodal model for operation to obtain the detection target of the user under detection; and
a model optimization module configured to store feedback data of the detection target of the user under detection, and optimize the vision-language multimodal model based on the feedback data.

5. An electronic device, comprising a memory and a processor, the memory being configured to store one or more computer instructions, wherein the one or more computer instructions are executed by the processor to implement the method for the object detection based on the user-defined categories according to of claim 1.

6. A computer-readable storage medium, wherein when computer programs stored in the computer-readable storage medium are executed by a computer, the method for the object detection based on the user-defined categories according to claim 1 is implemented.

7. The electronic device according to claim 5, wherein in the method, the obtaining the key phrases comprises:
selecting K_{Pred} samples according to a Gaussian distribution, wherein K_{Pred} is a non-zero natural number;
calculating \hat{x}₀, P^{l} and P^{r} using a trained f_{θ}(x_{μ}_{ᵢ}, Q, μᵢ) model, wherein the f_{θ}(x_{μ}_{ᵢ}, Q, μᵢ) model is a noisy neural network model, \hat{x}₀ denotes a predicted value of a phrase boundary point of a moment μᵢ, μ denotes a time series of a length φ, μ_{φ}=T, X_{μi-1} is iterated from i=φ to i=1,
$${x}_{{μ}_{i - I}} = \sqrt{I - {β}_{{μ}_{i - I}}} {\hat{x}}_{0} + \sqrt{{β}_{{μ}_{i - I}}} \frac{{x}_{{μ}_{i}} - \sqrt{I - {β}_{{μ}_{i}}} {\hat{x}}_{0}}{\sqrt{{β}_{{μ}_{i}}}} ,$$
X_{μi} and X_{μi-1} denote two neighboring samples of the K_{Pred} samples, β_{μi-1} and β_{μi} denote variance coefficients of a predefined Gaussian distribution, Q denotes sentences in the text data, P^{l} and P^{r} denote probabilities of boundary points on left and right sides of a phrase, respectively,
$${C}_{QX}^{l} = {C}_{Q} {Z}_{Q}^{l} + {CxZ}_{X}^{l} , {P}^{l} = G ( {C}_{QX}^{l} ) , {C}_{QX}^{r} = {C}_{Q} {Z}_{Q}^{r} + {CxZ}_{X}^{r} , {P}^{r} = G ( {C}_{QX}^{r} ) ,$$
$${Z}_{Q}^{l} , {Z}_{X}^{l} , {Z}_{Q}^{r} , {Z}_{X}^{r}$$
denote trainable parameter matrixes, G(·) denotes a trainable two-layer perception network, C_{Q} denotes an output code after Q is input into the f_{θ}(x_{μ}_{ᵢ}, Q, μᵢ) model, and C̅_{X} denotes enhanced noise sampling;
analyzing boundary points
$${( {l}_{i} , {r}_{i} )}_{i = 0}^{{K}_{Pred}}$$
of K_{Pred} candidate phrases according to probability values of the boundary points, wherein
$${l}_{i} = arg max {P}_{i}^{l} , {r}_{i} = arg max {P}_{i}^{r} ,$$
and l and r denote left and right boundary points of the phrase, respectively;
selecting candidate phrases having the same left and right boundary points and highest probability values, summarizing and filtering the candidate phrases, and discarding candidate phrases whose probability values are less than a third preset threshold to obtain the key phrases.

8. The electronic device according to claim 5, wherein in the method, before the enhancing the text characterizations using the contextual vector:
inputting the text descriptions into the vision-language multimodal model in sequence for calculation to obtain detection results, feeding back the detection results to the user under detection, the user under detection marking the detection results as correct or incorrect, when a marked detection result is incorrect, enhancing the text description corresponding to the detection result.

9. The computer-readable storage medium according to claim 6, wherein in the method, the obtaining the key phrases comprises:
selecting K_{pred} samples according to a Gaussian distribution, wherein K_{Pred} is a non-zero natural number;
calculating \hat{x}₀, P^{l} and P^{r} using a trained f_{θ}(x_{μ}_{ᵢ}, Q, μᵢ) model, wherein the f_{θ}(x_{μ}_{ᵢ}, Q, μᵢ) model is a noisy neural network model, \hat{x}₀ denotes a predicted value of a phrase boundary point of a moment μᵢ, μ denotes a time series of a length φ, μ_{φ}=T, X_{μi-I} is iterated from i=φ to i=I,
$${x}_{{μ}_{i - I}} = \sqrt{I - {β}_{{μ}_{i - I}}} {\hat{x}}_{0} + \sqrt{{β}_{{μ}_{i - I}}} \frac{{x}_{{μ}_{i}} - \sqrt{I - {β}_{{μ}_{i}}} {\hat{x}}_{0}}{\sqrt{{β}_{{μ}_{i}}}} ,$$
X_{μi} and X_{μi-I} denote two neighboring samples of the K_{Pred} samples, β_{μi-I} and β_{μi} denote variance coefficients of a predefined Gaussian distribution, Q denotes sentences in the text data, P^{l} and P^{r} denote probabilities of boundary points on left and right sides of a phrase, respectively,
$${C}_{QX}^{l} = {C}_{Q} {Z}_{Q}^{l} + {CxZ}_{X}^{l} , {P}^{l} = G ( {C}_{QX}^{l} ) , {C}_{QX}^{r} = {C}_{Q} {Z}_{Q}^{r} + {CxZ}_{X}^{r} , {P}^{r} = G ( {C}_{QX}^{r} ) ,$$
$${Z}_{Q}^{l} , {Z}_{X}^{l} , {Z}_{Q}^{r} , {Z}_{X}^{r}$$
denote trainable parameter matrixes, G(·) denotes a trainable two-layer perception network, C_{Q} denotes an output code after Q is input into the f_{θ}(x_{μ}_{ᵢ}, Q, μᵢ) model, and C̅_{X} denotes enhanced noise sampling;
analyzing boundary points
$${( {l}_{i} , {r}_{i} )}_{i = 0}^{{K}_{Pred}}$$
of K_{Pred} candidate phrases according to probability values of the boundary points, wherein
$${l}_{i} = arg max {P}_{i}^{l} , {r}_{i} = arg max {P}_{i}^{r} ,$$
and l and r denote left and right boundary points of the phrase, respectively;
selecting candidate phrases having the same left and right boundary points and highest probability values, summarizing and filtering the candidate phrases, and discarding candidate phrases whose probability values are less than a third preset threshold to obtain the key phrases.

10. The computer-readable storage medium according to claim 6, wherein in the method, before the enhancing the text characterizations using the contextual vector:
inputting the text descriptions into the vision-language multimodal model in sequence for calculation to obtain detection results, feeding back the detection results to the user under detection, the user under detection marking the detection results as correct or incorrect, when a marked detection result is incorrect, enhancing the text description corresponding to the detection result.
